(19) United States
(12) Patent Application Publication
(10) Pub. No.: US 2021/0145679 A1
(43) Pub. Date: May 20, 2021

(54) INFLATABLE AIR MATTRESS

(71) Applicant: Caremed Supply Inc., New Taipei City (TW)

(72) Inventors: BING-CHENG GAO, New Taipei City (TW); CHIH-HUNG LIN, New Taipei City (TW)

(21) Appl. No.: 16/687,628

(22) Filed: Nov. 18, 2019

(51) Int. Cl. A61G 7/057; A47C 21/04; A47C 27/08

(52) U.S. Cl. CPC A61G 7/05784; A61G 7/05769; A47C 27/082; A47C 21/044

(57) ABSTRACT

The inflatable air mattress of the present invention comprises: a plurality of supporting air cells, a plurality of heat dissipating air cells and an inflating device. The supporting air cells are arranged in parallel to form a supporting mattress surface. The heat dissipating air cell is connected to one side of the supporting air cell. The heat dissipating air cell is provided with a plurality of air holes. The inflating device is capable of inflating the heat dissipating air cells and the supporting air cells with gas. The gas will be discharged from the air holes to form a heat dissipating airflow toward the support mattress surface. The present invention creates airflow through separately spaced heat dissipating air cells de, so that the air cells are not pressed by the patient, improving the lack of easily obstructed in airflow supply in the conventional mattress.

### FIELD OF THE INVENTION

The present invention relates to an inflatable air mattress providing heat dissipating airflow from the mattress, and more particularly, to one having separate heat dissipating cells to generate the airflow.

### BACKGROUND

For patients who, because of illness, has difficulty in moving and need to stay in bed for a long time, in order to avoid skin lesions caused by staying in bed for a long time, it needs to regularly ask someone to help turn over bedridden people to help the skin maintain blood circulation, which will cause bedridden people and their family must bear considerable manpower costs in the care matters. Therefore, there is an inflatable air mattress on the market that can control the contraction and expansion of the air cell to change the pressure distribution on the body of the lying-down person.

However, in order to ensure the expansion shape of the inner air cell, such air cell type air mattress is often made of an air-impermeable material to form an air cell structure inside the air mattress, so that the air cell itself has a limited heat dissipation capability. Although the lying-down person can mitigate the skin lesions caused by prolonged pressure through contracts and expands the air cell of the air mattress, on the other hand, because the air mattress itself is not permeable, the patient often feels stuffy and uncomfortable, and more seriously even the patient suffers from other illness such as eczema. Even if the lying-down person uses a blowing device such as an electric fan, usually because the quilt covering the patient's body blocks the ventilation of contact portion between the lying-down person and the air mattress, it causes obvious problem in heat dissipation.

In view of this problem in heat dissipation, at present, there already are a plurality of air holes that are separately arranged on the tops of the plurality of air cells which are formed side by side to form a mattress surface, so that the air in the air cell can be directly blown to the lying-down person by the plurality of air holes, thereby taking away the moisture and the heat. However, in practical use, the lying surface of the lying-down person may cover the air hole, thereby reducing the heat dissipation capacity of the inflatable air mattress itself. Therefore, it is necessary to improve and innovate.

### SUMMARY

The main purpose of the present invention is to provide an inflatable air mattress with separate heat dissipating air cells to generate airflow, so that the heat-dissipating air cell is not pressed by the patient, which improves the defect of blocking airflow supply in the air mattress, thereby raising the heat dissipation efficacy of the air mattress.

The secondary purpose of the present invention is that the heat-dissipating air cell has a simple structure and has a spacer inside to prevent adjacent adhesion between the inner wall surfaces, which makes the heat dissipating air cells rapidly expand and deform when receiving gas.

Yet a purpose of the present invention is that the heat dissipating airflow generated by the air dissipating air cells keeps along a shortest straight path and blows to the support mattress surface of the air mattress, so that the gas inside the air mattress can be quickly convected to the support mattress surface, thereby rapidly taking away heat to achieve comfortable lying effect.

To achieve above purpose, an inflatable air mattress of the present invention comprises a plurality of supporting air cells, a plurality of heat dissipating air cells and an inflating device. The supporting air cells are arranged in parallel to form a supporting mattress surface; the heat dissipating air cells are separately connected to one side of the supporting air cells, and has a separation distance between the heat dissipating air cells and the supporting mattress surface formed with the supporting air cells, and the heat dissipating air cells are arranged with a plurality of air holes for discharging the gas; the inflating device has a plurality of inflation tubes used to respectively communicate with the supporting air cells and the heat dissipating cell cells, and selectively supply gas to at least one of the plurality of inflation tubes.

In a practical embodiment, the supporting mattress surface has an upper body region, a waist-hip region, and a lower body region, and the heat dissipating air cells are separately disposed on the plurality of supporting air cells in the waist-hip region, whereby better heat dissipation effect is achieved by using a few heat dissipating air cells.

Wherein, the heat dissipating air cell is configured as a single layer body to enclose surrounding, and the heat dissipating air cell forms air chamber inside. And the air chamber is internally arranged with a spacer to prevent the inner wall surfaces of the heat dissipating air cell from all abutting each other, such that when air enters the heat dissipating air cell, the incomplete deformation of the cell body can be avoided.

Furthermore, the heat dissipating air cell and the supporting air cell are adjacent to each other to form a contact area, and the periphery of the contact area is formed with a mutually connective fixed section and an unconnected free section. The free section is located on an adjacent side of the contact area close to the supporting mattress surface, while the fixed section is located on the other sides of the contact area away from the supporting mattress surface, such that the deformation direction of the heat dissipating air cell caused by filling with gas can be oriented toward the supporting mattress surface.

Furthermore, the fixed section is formed with a first connecting portion, a second connecting portion and a third connecting portion to be fixedly connected with the supporting air cell, and the second connecting portion is located at bottom side of the contact area, while the first connecting portion and the third connecting portion are respectively adjacent to opposite ends of the second connecting portion, whereby keeping the heat dissipating airflow in a traveling direction substantially perpendicular to the supporting mattress surface.

In another practical embodiment, the supporting air cell is arranged with a plurality of auxiliary air holes, whereby the air mattress has two sets of heat dissipating airflow sources at different height positions. The plurality of inflation tubes has a first inflation tube, a second inflation tube and a third inflation tube. The first inflation tube communicates with the supporting air cells arranged at odd positions, the second inflation tube communicates with the supporting air cells arranged at even positions, and the third inflation tube communicates with the heat dissipating air cells.

The present invention features a plurality of heat dissipating air cells separately arranged adjacent to the plurality of supporting air cells forming the supporting mattress surface, and a separation distance is formed between the air holes on the heat dissipating air cell and the supporting mattress surface, whereby the heat dissipating air cell is avoided from being pressed by the patient. The heat dissipating airflow keeps blowing to the support mattress surface, thereby improving the heat dissipation effect of the air mattress. Furthermore, the heat dissipating air cell of the present invention has a simple structure, low manufacturing cost, and a spacer arranged inside, which allows the heat dissipating air cell to rapidly expand and deform when receiving gas.

### BRIEF DESCRIPTION OF THE DRAWINGS

FIG. 1 is a schematic illustrating perspective view of the inflatable air mattress of the present invention according to the first preferred embodiment;

FIG. 2 is a schematic illustrating section view taken along section A-A in FIG. 1;

FIG. 3 is a schematic illustrating section view taken along section B-B in FIG. 1;

FIG. 4 is a schematic illustrating section view taken along section C-C in FIG. 1;

FIG. 5 is a schematic illustrating the heat dissipating airflow generated by the heat dissipating air cell;

FIGS. 6A and 6B are schematic illustrating alternate inflation of the supporting air cell; and

FIG. 7 is a schematic illustrating cross section of the inflatable air mattress according to the second preferred embodiment.

### DETAILED DESCRIPTION OF PREFERRED EMBODIMENTS

In order to further understand the structure, usage and features of the present invention more clearly and in detail, the present invention is described in detail below with references to the accompanying drawings and specific preferred embodiments:

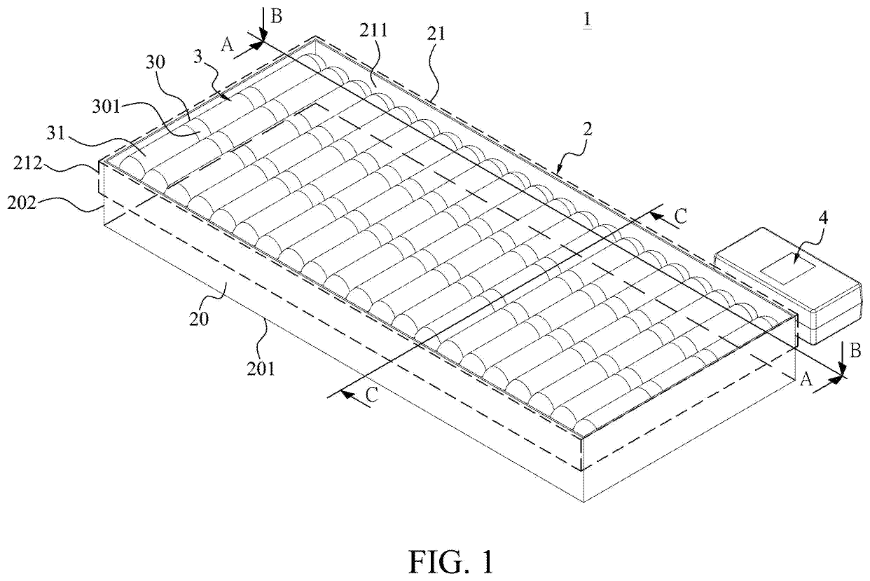

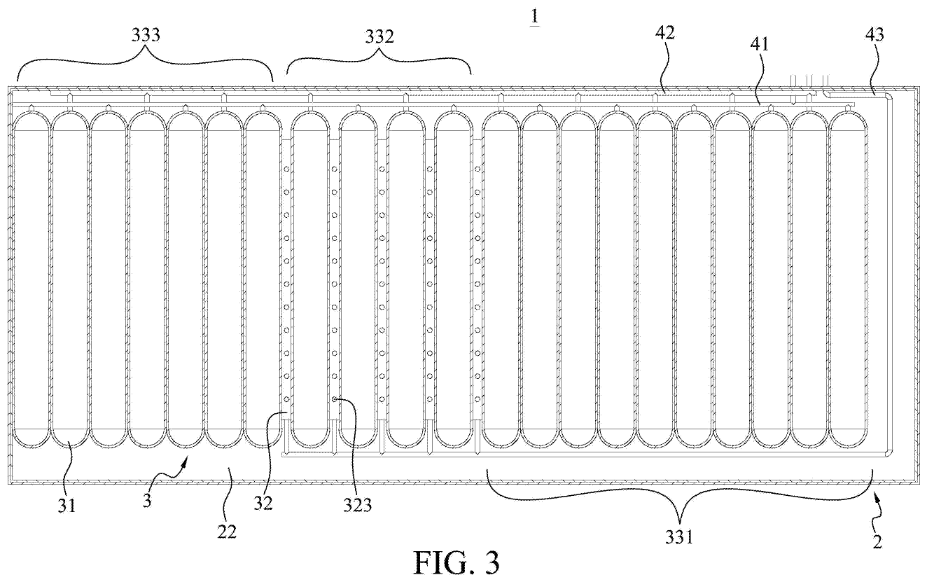

Please refer to FIGS. 1 and 3. An inflatable air mattress 1 of the present invention can generate the alternate inflation-deflation effect for mattress, and can make air circulation inside the air mattress, whereby the damp heat generated by the lying-down person in the lying position can be quickly dissipated. The air mattress 1 comprises a mattress cover 2, a mattress body 3 and an inflating device 4, wherein the mattress cover 2 has a lower cover body 20 and an upper cover body 21; the lower cover body 20 is arranged with a bottom surface 201 and a inner wall surface 202 surrounding the periphery of the bottom surface 201; the upper cover body 21 is arranged with a top surface 211 and an outer wall surface 212 surrounding the periphery of the top surface 211, and the outer wall surface 212 is overlapped with the outer side of the inner wall surface 202 such that the top surface 211, the bottom surface 201 and the inner wall surface 202 together form an installation space 22 capable of accommodating the mattress body 3 and the inflating device 4.

The mattress body 3 is mounted in the installation space 22 of the cover body, and includes at least one positioning member 30, a plurality of supporting air cells 31, and a plurality of heat dissipating air cells 32. The at least one positioning member 30 has a plurality of rings 301 connected with each other in succession, and supporting air cells 31 separately pass through the rings 301 one to one; the head end and the rear end of the supporting air cells 31 are aligned with each other, so that the supporting air cells 31 are arranged in parallel to form a supporting mattress surface 33, and the supporting mattress surface 33 is covered by the upper cover body 21.

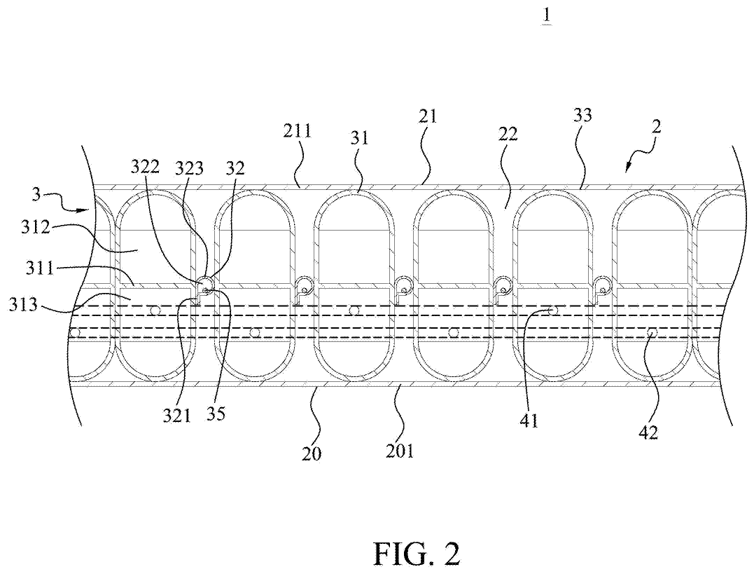

As shown in FIG. 2, the supporting air cell 31 is formed by inflating a single cell body, and the cell body has a division portion 311 therein to be partitioned into an upper air chamber 312 and a lower air chamber 313 that communicate with each other.

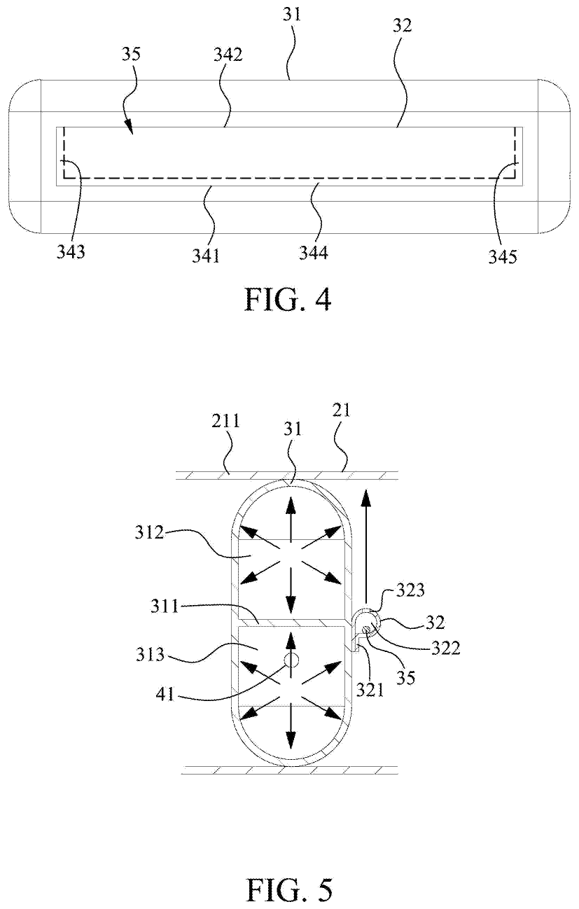

Please refer to FIGS. 2 and 4. The heat dissipating air cells 32 are one-to-one separately connected to the central position at the same side of the supporting air cells 31 (the right side as shown in FIG. 2), so that the heat dissipating air cell 32 and the supporting air cell 31 are adjacent to each other to form a contact area 34, and a space is formed between the heat dissipating air cell 32 and the supporting mattress surface 33; the heat dissipating air cell 32 is a single layer body 321 to fold over and enclose surrounding to form a gas chamber 322. The air chamber 322 is internally arranged with a spacer 35 to prevent the inner wall surfaces of the heat dissipating air cell 32 from all abutting each other, and the spacer 35 is composed of a soft material; besides, the heat dissipating air cell 32 is further arranged with a plurality of micro air holes 323 separately communicating with the air chamber 322, and when receiving the gas supplied by the inflating device 4, the air holes 323 will generate a heat dissipating airflow jetting toward the opening direction (see FIG. 5)

As shown in FIG. 2. The supporting mattress surface 33 formed with a plurality of supporting air cells 31 is configured as an upper body region 331, a waist-hip region 332, and a lower body region 333. The heat dissipating air cells 32 are separately arranged on the plurality of supporting air cells 31 in the waist-hip regions 332, thereby using less heat dissipating air cells 32 to achieve optimal damp heat removing effect. However, this is merely for convenient description, not to limit the number and position configuration of the supporting air cells 31, that is, the heat dissipating air cells may also be disposed on all the supporting air cells 31 or on the spaced supporting air cells 31.

As shown in FIG. 4, the periphery of the contact area 34 is formed with a non-displaceable fixed section 341 and a free section 342. The free section 342 is located on an adjacent side of the contact area 34 close to the supporting mattress surface 33, and the fixed section 341 is located on the other sides of the contact area 34 away from the supporting mattress surface 33, such that the deformation direction of the heat dissipating air cell 32 caused by filling with gas can be oriented toward the supporting mattress surface 33.

Wherein, the fixed section 341 is formed with a first connecting portion 343, a second connecting portion 344 and a third connecting portion 345 for being fixedly attached to the supporting air cell 31, and the second connecting portion 344 is located at bottom side of the contact area 34, while the first connecting portion 343 and the third connecting portion 345 are respectively adjacent to opposite ends of the second connecting portion 344, so that the heat dissipating air cell 32 in an inflated state can keep the heat dissipating airflow in a traveling direction substantially perpendicular to the supporting mattress surface 33.

Please refer to FIG. 3. The inflating device 4 is located outside the mattress cover 2, and has a plurality of inflating tubes passes though the mattress cover 2 to separately communicate with the supporting air cells 31 and the heat dissipating air cells 32 of the mattress body 3, as well as can inflate supporting air cells 31 and/or the heat dissipating air cells 32 with gas, so that the supporting air cells 31 and the heat dissipating air cells 32 have deformation of inflation because of expansion from gas. As shown in the figure, the inflating device 4 has a first inflation tube 41, a second inflation tube 42 and a third inflation tube 43. The first inflation tube 41 communicates with the supporting air cells 31 arranged at odd positions, the second inflation tube 42 communicates with the supporting air cells 31 arranged at even positions, and the third inflation tube 43 communicates with the heat dissipating air cells 32.

Please refer to FIG. 5. When the inflating device 4 inflates the heat-dissipating air cells 32 through the third inflation tube 43, the gas will start to flow radially from the surrounding of the spacer 35, so that the single layer body 321 of the heat dissipating air cell 32 is expanded from a flat state to an expansion state, and the gas will subsequently be discharged from the small air holes 323 to form the heat dissipating airflow.

Furthermore, the inflating device 4 can selectively inflate at least one of the first inflation tube 41, the second inflation tube 42 and the third inflation tube 43. Therefore, the inflating device 4 can have several operation states. First, the inflating device 4 can simultaneously inflate the first inflation tube 41 and the second inflation tube 42 to make a supporting mattress surface 33 without heat dissipation effect; when the user needs to make the inflatable air mattress 1 generate heat dissipation effect, the inflating device 4 inflates the third inflation tube 43, which makes the first inflation tube 41, the second inflation tube 42 and the third inflation tube 43 operate simultaneously.

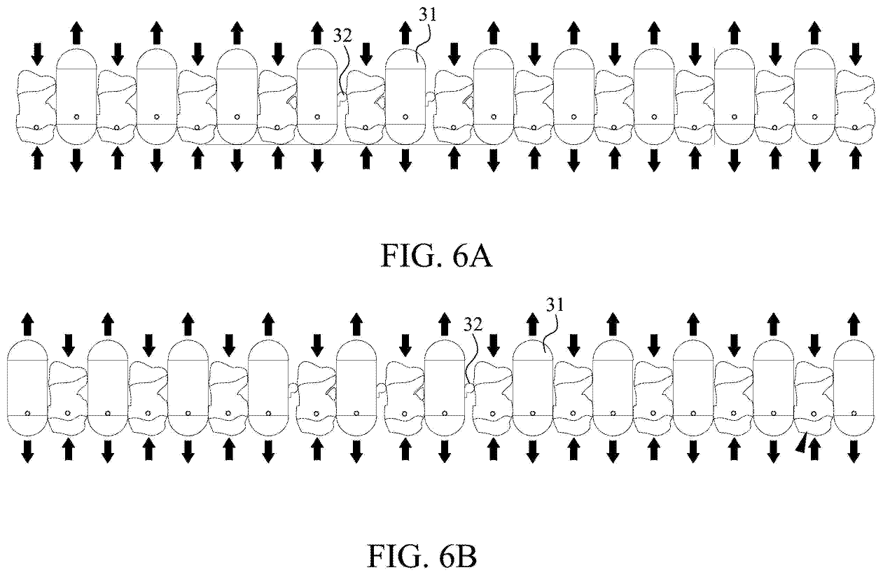

Please refer to FIG. 6A and FIG. 6B. Furthermore, when the user requires the inflatable air mattress 1 to have alternating function, the inflating device 4 is operated to alternately inflate the first inflation tube 41 and the second inflation tube 42. As shown in FIG. 6A, the inflating device 4 continuously inflates the first inflation tube 41 and stops the gas supply to the second inflation tube 42. At this time, the height of the supporting mattress surface 33 is maintained by the supporting air cells 31 at odd positions, while the supporting air cells 31 at the even positions will shrink so that the height cannot reach the supporting mattress surface 33. As shown in FIG. 6B, after alternating, the inflating device 4 will continuously inflate the second inflation tube 42 and stop the gas supply to the first inflation tube 41, at which time the height of the supporting mattress 33 is maintained by the supporting air cells 31 at the even positions, and the supporting air cells 31 at the odd positions will shrink.

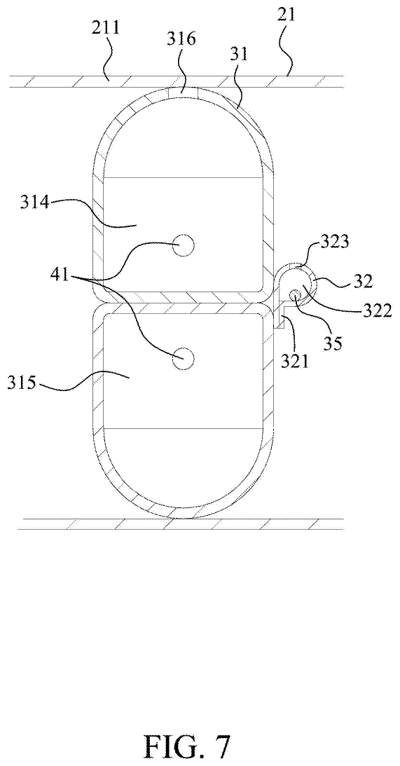

Finally, please refer to a second preferred embodiment of FIG. 7. The difference from the first preferred embodiment is in the structural form of the supporting air cell 31. The supporting air cell 31 of the inflatable air mattress 1 in the present invention can also be designed as jointly longitudinal arrangement of an upper cell body 314 and a lower cell body 315. Wherein, the upper cell body 314 is arranged with a plurality of auxiliary air holes 316, whereby the inflatable air mattress 1 has two sets of heat dissipating airflow sources at different height positions.

What is claimed is:

1. An inflatable air mattress, comprising:
a plurality of supporting air cells, arranged in parallel to form a supporting mattress surface for allowing a patient to lie down thereon;
a plurality of heat dissipating air cells, separately connected to one side of the supporting air cells, and having a separation distance between the heat dissipating air cell and the supporting mattress surface, wherein the heat dissipating air cells are arranged with a plurality of air holes; and
an inflating device having a plurality of inflation tubes used to respectively communicate with the supporting air cells and the heat dissipating cell cells, wherein the inflating device is capable of inflating heat dissipating air cells with gas, so that the heat dissipating air cells have deformation of inflation because of expansion from gas, and the gas will be discharged from the air holes to form a heat dissipating airflow toward the supporting mattress surface.

2. The inflatable air mattress according to claim 1, wherein the supporting mattress surface comprises an upper body region, a waist-hip region, and a lower body region, and the heat dissipating air cells are separately disposed on the plurality of supporting air cells in the waist-hip region.

3. The inflatable air mattress according to claim 1, wherein the heat dissipating air cell is configured as a single layer body to enclose surrounding.

4. The inflatable air mattress according to claim 1, wherein the heat dissipating air cell forms an air chamber inside, and the air chamber is internally arranged with a spacer to prevent the inner wall surfaces of the heat dissipating air cell from all abutting each other.

5. The inflatable air mattress according to claim 1, wherein the heat dissipating air cell and the supporting air cell are adjacent to each other to form a contact area, and the periphery of the contact area is formed with a fixed section and a free section, wherein the free section is located on an adjacent side of the contact area close to the supporting mattress surface, while the fixed section is located on the other sides of the contact area away from the supporting mattress surface, such that the deformation direction of the heat dissipating air cell caused by filling with gas can be oriented toward the supporting mattress surface.

6. The inflatable air mattress according to claim 5, wherein the fixed section is formed with a first connecting portion, a second connecting portion and a third connecting portion to be fixedly attached to the supporting air cell, and wherein the second connecting portion is located at bottom side of the contact area, while the first connecting portion and the third connecting portion are respectively adjacent to opposite ends of the second connecting portion, whereby keeping the heat dissipating airflow in a traveling direction substantially perpendicular to the supporting mattress surface.

7. The inflatable air mattress according to claim 1, wherein the supporting air cell is arranged with a plurality of auxiliary air holes.

8. The inflatable air mattress according to claim 1, wherein the plurality of inflation tubes has a first inflation tube, a second inflation tube and a third inflation tube, and wherein the first inflation tube communicates with the supporting air cells arranged at odd positions, the second inflation tube communicates with the supporting air cells arranged at even positions, and the third inflation tube communicates with the heat dissipating air cells.
